(19) United States
(12) Patent Application Publication
(10) Pub. No.: US 2008/0275946 A1
(43) Pub. Date: Nov. 6, 2008

(54) Smart Scheduler Capable of Reflecting Change of Situation

(75) Inventors: We Duke Cho, Gyeonggi-do (KR); Gil Huh, Gyeonggi-do (KR); Seong Hun Yoo, Gyeonggi-do (KR); Hui Jeong Park, Gyeonggi-do (KR)

Correspondence Address: HARNESS, DICKEY, & PIERCE, P.L.C, 7700 Bonhomme, Suite 400, ST. LOUIS, MO, 63105, US

(73) Assignee: Ajou University Industry Cooperation Foundation, Gyeonggi-do (KR)

(21) Appl. No.: 12/158,219

(22) PCT Filed: Jan. 26, 2006
(86) PCT No.: PCT/KR2006/000311

§ 371 Date: Jun. 19, 2008

(30) Foreign Application Priority Data
Dec. 23, 2005 (KR) 1020050128662

(51) Int. Cl. G06F 15/16

(52) U.S. Cl. 709/203

(57) ABSTRACT

Disclosed is a smart scheduler reflecting change of situation. The smart scheduler reflecting change of situation includes an interface unit and an alarm time decision unit. The interface unit both sends and receives contextual information to/from an external service-providing source. The alarm time decision unit reflects the contextual information that is received and updated from the external service-providing source, so that it may decide a final alarm time for performing a fixed schedule, even if any situation change occurs. The smart scheduler has the advantage that the determined schedule may be performed in the time in which a user designates, by differently setting up the alarm time according to the situation changes, whatever situation change brings about.

### TECHNICAL FIELD

The present invention generally relates to a scheduler, particularly, to a smart scheduler reflecting change of situation.

### BACKGROUND ART

Discriminated services are required to provide for respective individuals under ubiquitous environment. An intelligent personal scheduling management is one of these services.

An user of a scheduling management system is, for example, scheduled to have a meeting at a specified location in a specified time. Under a general scheduling management system, an alarm is previously set up so that it only may sound in an earlier arbitrary time than the specified time in order to announce the departure time for the specified location.

The general scheduling management system, however, may not adequately correspond to various situation changes. That is, it does not consider the current states of a user and the schedule partner, a moveable condition of the user and the state of the meeting place, etc.

In other words, the user may not arrive in the place within a desired time if he/she departs at the alarm time set up due to any change of unexpected situations such as traffic, weather and the change of the meeting place, etc. Therefore, it may cause a problem in which an exact scheduling management is not performed.

### DISCLOSURE OF INVENTION

### Technical Solution

The technical task of the present invention provides a smart scheduler capable of providing an alarm service reflecting any situation change by adjusting the schedule of a user in consideration of the change of various situations.

The smart scheduler reflecting a situation change according to the embodiment of the present invention in order to achieve the technical task may comprise an interface unit and an alarm time decision unit.

The interface unit may send and receive any contextual information with external service-providing sources. The alarm time decision unit may reflect updated contextual information which is received from the external service-providing sources, so that it may finally decide a final alarm time in which a user can perform his/her schedule in the designated schedule, even though any situation change occurs.

The alarm time decision unit may comprise a provisional alarm time configuration unit, a confirmation unit and a final alarm time output unit.

The provisional alarm time configuration unit sets up a provisional alarm time being different from the schedule time in response to the updated contextual information. The confirmation unit confirms the validity of the provisional alarm time. A final alarm time configuration unit may comprise a final alarm time output unit in which differently outputs the final alarm time according to the result of the confirmation unit.

The smart scheduler is a scheduler that makes the final alarm time to be a departure time to arrive in the scheduled destination within the schedule time. The provisional alarm time is set up in response to an average turnaround time determined by an average turnaround time to the destination determined by the contextual information.

The confirmation unit confirms whether the time of adding the average turnaround time to the provisional alarm time falls in the interval between the schedule time and the time which either adds and subtracts an earlier arrival allowed time from the schedule time. In case the time of adding the average turnaround time to the provisional alarm time is later than the schedule time or faster than the time of subtracting the earlier arrival allowed time from the schedule time, in the confirmation result of the confirmation unit, the final alarm time output unit outputs the corrected provisional alarm time as the final alarm time.

The final alarm time output unit, in case the time of adding the average turnaround time to the provisional alarm time is later than the schedule time, outputs the time of being fast as the delay time subtracting the average turnaround time from the schedule time than the provisional alarm time as the final alarm time. The final alarm time output unit, in case the time of adding the average turnaround time to the provisional alarm time is earlier than the time of subtracting the earlier arrival allowed time from the schedule time, outputs a time being late as the lead time subtracting the average turnaround time from the schedule time than the provisional alarm time as the final alarm time.

The final alarm time output unit, in case the time of adding the average turnaround time to the provisional alarm time falls between the schedule time and the time that either adds and subtracts the earlier arrival allowed time from the schedule time, outputs the provisional alarm time as the final alarm time.

The alarm time decision unit increases the update frequency of the contextual information as it draws to the schedule time.

The outside service providing subjects may be web or user.

### Advantageous Effects

The smart scheduler reflecting change of situation according to the present invention has the advantage that a user may perform his/her designated schedule within a designated time, although situation changes bring about, by differently setting up an alarm time according to situation changes.

### BRIEF DESCRIPTION OF THE DRAWINGS

Provided is the simple description for the drawings to be referred the detailed description of this invention for more understanding.

FIG. 1 is a schematic diagram illustrating a smart scheduler for both sending and receiving contextual information according to an embodiment of the present invention.

FIG. 2 is a brief block diagram illustrating a smart scheduler of FIG. 1.

FIG. 3 is a block diagram illustrating an alarm time decision unit of FIG. 2.

FIGS. 4 through 6 are drawings illustrating the operation of the alarm time decision unit of FIG. 3.

### BEST MODE FOR CARRYING OUT THE INVENTION

The present invention will be described in detail with reference to the accompanying drawings.

Hereinafter, the present invention and the preferred embodiments are illustrated with reference to the attached drawings. The same reference numerals shown in each drawing show the same members.

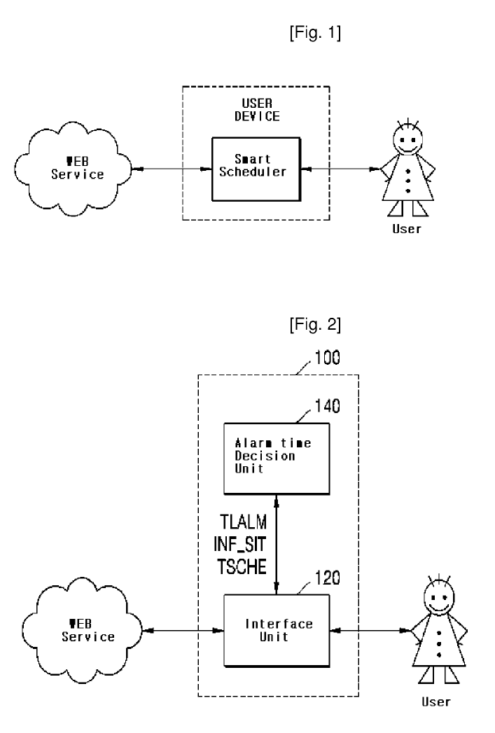

FIG. 1 is a schematic diagram illustrating a smart scheduler for both sending and receiving contextual information according to an embodiment of the present invention.

Referring to FIG. 1, the smart scheduler according to an embodiment of the present invention, sends and receives contextual informations from web service or user. The smart scheduler according to an embodiment of the present invention, for example, informs the user of the departure time in which he/she may arrive at a scheduled destination in the schedule time. At this time, the contextual information may be the schedule time, user's current location, the destination location, traffic, weather and traffic accident occurrence, etc.

FIG. 2 is a brief block diagram illustrating a smart scheduler of FIG. 1.

Referring to FIG. 2, the smart scheduler 100 reflecting situation changes is comprised of an interface unit 120 and an alarm time decision unit 140.

The interface unit 120 sends and receives contextual information (INF_SIT) from an external service-providing source. As described in the above, the external service-providing source may be web or user. The interface unit 120 manages physical communication with the web or user. The interface unit 120 may be an adaptor for integration middleware, a serial communications module, Universal Plug & Play (UpnP), and Web service communications module.

The interface unit 120 may be classified into a contextual information adapter (non shown) and a device adapter (non shown). The contextual information adapter manages communication function with the web service. In other words, the contextual information adapter is necessary for the smart scheduler 100 to either search services available to the web or execute a service. Moreover, the device adapter manages the communications between the smart scheduler 100 and a device.

At this time, the device, for example, may be TV, a mobile phone and PDA etc., as an apparatus in which the smart scheduler 100 is incorporated.

The alarm time decision unit 140 outputs the final alarm time TLALM. The final alarm time TLALM reflects the contextual information that is received from the external service-providing source and becomes update. Therefore, the final alarm time TLALM means the time that a user gets ready to perform the schedule in considering the situation changes. A departure time, for this example, may be the final alarm time TLALM.

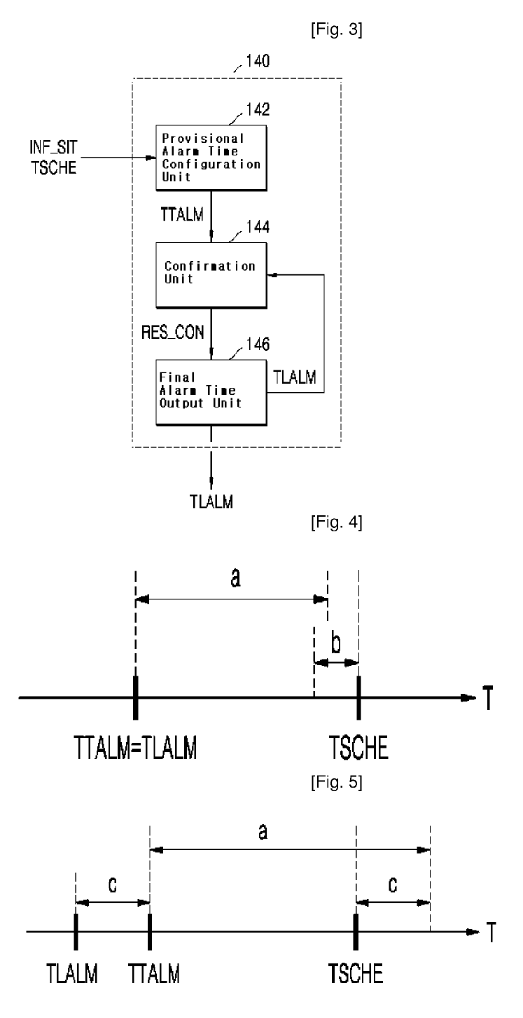

FIG. 3 is a block diagram illustrating an alarm time decision unit of FIG. 2.

FIGS. 4 through 6 are drawings illustrating the operation of the alarm time decision unit of FIG. 3.

Referring to FIGS. 3 and 4 through 6, the alarm time decision unit 140 is comprised of a provisional alarm time configuration unit 142, a confirmation unit 144 and a final alarm time output unit 146. The operation of the smart scheduler according to an example of the invention is illustrated as below.

The provisional alarm time configuration unit 142 differently sets up a provisional alarm time TTALM in response to the contextual information INT_SIT that becomes update. The provisional alarm time TTALM is determined in response to an average turnaround time (a) determined by the contextual information INF_SIT including user's current location and destination location, etc.

The next is the algorithm for calculating a provisional alarm time TTALM.

Start;
a0 = CallWebservice (CurrentLoca, DestLoca, TSCHE);
TTALM = TSCHE − a0;
Repeat;
a = CallWebservice (INF_SIT, TTALM);
TTALM = Respond (a, TTALM);
Until t = x;
End.

The CallWebservice is a command in which the smart scheduler 100 requests the contextual information INF_SIT to the web. The aO means an initial turnaround time. Moreover, the CurrentLoca and DestLoca mean the user's current position and the destination location, respectively. The Respond is the function determining the provisional alarm time TTALM of current cycle in response to both the provisional alarm time TTALM checked in the previous cycle and the average turnaround time (a). The contextual information INF_SIT may be the informations such as traffic and weather, etc. including user's current position and destination location.

The initial provisional alarm time TTALM is the time subtracting the initial turnaround time a0 from the schedule time TSCHE. As described in the above, the user's current position and the information to the destination thereby are changed by time. Therefore, the provisional alarm time TTALM is also changed. The updates as described in the above repeat until t=x. At this time, a specific time (x) may be decided by a developer. The update of the contextual information INF_SIT is repeated by the predetermined cycle and it will be described later, with respect to this.

A confirmation unit 144 confirms the effectiveness of the provisional alarm time TTALM. That is, it confirms whether a successful schedule may be performed in arriving at the destination location in the schedule time TSCHE, when a user departs for the destination location in the provisional alarm time TTALM.

Concretely, the confirmation unit 144 confirms whether the time of adding the average turnaround time (a) to the provisional alarm time TTLAM falls into a time between the schedule time TSCHE and a time of subtracting an earlier arrival allowed time (b) from the schedule time TSCHE. At this time, the earlier arrival allowed time (b) means the time to be allowed excuse, although a user quickly arrives in the destination location than the schedule time TSCHE.

Referring to FIGS. 3 through 6, FIG. 4 shows the case that the time of adding the average turnaround time (a) to the provisional alarm time TTALM falls into between the schedule time TSCHE and the time of subtracting the earlier arrival allowed time (b) from the schedule time TSCHE.

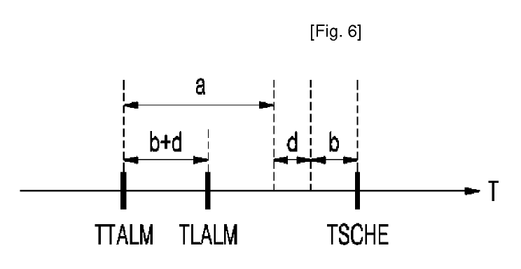

FIG. 5 shows that the time of adding the average turnaround time (a) to the provisional alarm time TTALM is later than the schedule time TSCHE. FIG. 6 shows that the time of adding the average turnaround time (a) to the provisional alarm time TTALM is earlier than the time of subtracting the earlier arrival allowed time (b) from the schedule time TTALM.

That is, the confirmation unit 144 judges a relation between the schedule time TSCHE and the time of adding the average turnaround time (a) to the provisional alarm time TTALM so that it determines the effectiveness of the provisional alarm time TTALM.

The next organizes the operation of the confirmation unit 144 as a formula. At this time, (1) through (3) shows the cases of the FIGS. 4 through 6, respectively.

TSCHE−b<=TTALM+a <=TSCHE (1)

TTALM+a>TSCHE (2)

TTALM+a<TSCHE−b (3)

Referring to FIGS. 3 and 6, a final alarm time output unit 146 outputs a time modified the provisional alarm time TTALM as the final alarm time TLALM, in case that a time of adding the average turnaround time (a) to the provisional alarm time TTALM is either later than the schedule time TSCHE or faster than the time of subtracting the earlier arrival allowed time (b) from the schedule time STCHE, as con-firmation result RES_CON of the confirmation unit 144, as shown in both FIGS. 5 and 6.

Preferably, the final alarm time TLALM may be a time being faster than the provisional alarm time TTLAM as much as a delayed time (c) (c=TSCHE−a) of subtracting the average turnaround time (a) from the schedule time TSCHE, as shown in FIG. 5 (TLALM=TTALM−c). In the meantime, the final alarm time TLALM may be a time being later than the provisional time TTALM as much as a lead time (b+d) (b+d=TSCHE−a) of subtracting the average turnaround time (a) from the schedule time TSCHE (TLALM=TTALM+(b+d)).

That is, the time of subtracting the average turnaround time to be changed according to situations from the schedule time is decided to be the final alarm time so that a user may arrive in the destination in the schedule time, although any situation change occurs.

The final alarm time output unit 146 outputs the provisional alarm time TTALM as the final alarm time TLALM, in case the time of adding the average turnaround time (a) to the provisional alarm time TTALM falls into between the schedule time TSCHE and the time of subtracting the earlier arrival allowed time (b) from the schedule time TSCHE (TLALM=TTALM).

However, as described in the above, the final alarm time TLALM may be changed to the time of t=x, because the contextual information INF_SIT is updated by time. Moreover, the confirmation unit 144 may verify its effectiveness about the final alarm time TLALM to be modified. Therefore, the final alarm time TLALM consequently outputs the time of adding the average turnaround time (a) to the provisional alarm time TTALM as a time between the schedule time TSCHE and a time subtracting the earlier arrival allowed time (b) from the schedule time TSCHE. The next is the algorithm showing the process of outputting the final alarm time TLALM.

Start;
Repeat;
a = callWebservice(CurrentLoca, DestLoca, TTALM);
correction = TSCHE − a;
if (TTALM + a) > TSCHE
TLALM = TTALM − correction;
Else if (TTALM + a) < TSCHE − b
TLALM = TTALM + correction;
Until (TSCHE − b <= TTALM + a <= TSCHE)
End.

At this time, the correction is the delay time (c), in case TTALM+a>TSCHE in FIG. 5, and is the lead time (b+d), in case TTALM+a<TSCHE−b in FIG. 6.

As the alarm time decision unit 140 draws to the schedule time TSCHE, it may improve the correctness of alarm service for the scheduler 100 by increasing the update frequency of the contextual information INF_SIT.

The next is the algorithm calculating one example of the update cycles of the contextual information INF_SIT.

Start;
Situation Checking Time (SCT) = CurrentTime − NextCheckingTime
(min);
If (CurrentTime − TTALM) > 5hr
NextCheckingTime = TTALM + 300min;
Else if (CurrentTime − TTALM) <= 5hr
1/z * (CurrentTime − TTALM)2 ;
Else (1/z * (CurrentTime − TTALM)2 ) < 10
10;
End.

According to the algorithm, the smart scheduler 100 starts the confirmation of the contextual information INF_SIT from 5 hours prior to the initial provisional alarm time. According to the algorithm, the confirmation of the contextual information becomes frequent, as the provisional alarm time TTALM comes close to current time. Moreover, the confirmation interval may be compulsively adjusted as 10 minutes in case the confirmation interval falls within 10 minutes. At this time, a developer may control the confirmation cycle by appropriately diversifying the value of z.

However, if the smart scheduler for itself may confirm current location of user under the ubiquitous environment, it may be able to provide a new final alarm time irrespective of the situation confirmation cycle.

Furthermore, the smart scheduler 100 may guess the change of the contextual information INF_SIT. This guess is possible under the assumption that the smart scheduler 100 and/or a contextual information-supplying source keep history, that is, data for the previous situation changes. That is, the smart scheduler 100 continuously receives the contextual informations from web etc., so as to make them database (DB). The smart scheduler 100 may match a situation that is most similar to the current situation from the DB for the contextual information INF_SIT, and reflects it in setting up the alarm time.

The final alarm time of being set up in this way may be informed of a user in different forms. The alarm time may be informed of a user through a lamp in which the smart scheduler is mounted. It may be used, for example, the adjustment of the intensity of lamplight or change of color. Particularly, an alarm message may be able to be sent to a device closest to a user, by connecting all devices to one server under the ubiquitous environment (the lamp, in the example).

Unless otherwise defined, all terms (including technical and scientific terms) used herein have the same meanings as commonly understood by one of ordinary skill in the art to which the present invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. Although a few example embodiments of the present invention have been described, those skilled in the art will readily appreciate that many modifications are possible in the example embodiments without materially departing from the novel teachings and advantages of the present invention. Accordingly, all such modifications are intended to be included within the scope of the present invention as defined in the claims. The present invention is defined by the following claims, with equivalents of the claims to be included therein.

### INDUSTRIAL APPLICABILITY

This invention may be utilized in the area of developing systems related to the ubiquitous computing environment.

1. A smart scheduler, comprising:
an interface unit both sending and receiving a contextual information to/from an external service-providing source; and
an alarm time decision unit deciding a final alarm time for a user to perform a schedule in a schedule time which is decided, although any situation change occurs, reflecting the contextual information which is received from the external service-providing source and updated, wherein the alarm time decision unit comprises;
a provisional alarm time configuration unit which differently sets up a provisional alarm time in response to the contextual information;
a confirmation unit confirming the effectiveness of the provisional alarm time; and,
a final alarm time output unit for outputting the final alarm time in response to the result of the confirmation unit.

2. The smart scheduler of claim 1, wherein the final alarm time is a time a user departs for a destination.

3. The smart scheduler of claim 2, wherein the provisional alarm time is set up in response to an average turnaround time required to the destination according to the contextual information.

4. The smart scheduler of claim 3, wherein the confirmation unit confirms whether the time of adding the average turnaround time to the provisional alarm time falls between the schedule time and the time of subtracting the earlier arrival allowed time from the schedule time.

5. The smart scheduler of claim 4, wherein the final alarm time output unit outputs the final alarm time by correcting the provisional alarm time, in case the time of adding the average turnaround time to the provisional alarm time, according to the confirmation result of the confirmation unit, is later than the schedule time or faster than the time of subtracting the earlier arrival allowed time from the schedule time.

6. The smart scheduler of claim 5, wherein the final alarm time output unit outputs a time being faster as much as a delayed time of subtracting the average turnaround time from the schedule time as the final alarm time, in case a time of adding the average turnaround time to the provisional time is later than the schedule time, and outputs a time being later as much as a lead time of subtracting the average turnaround time from the schedule time as the final alarm time, in case a time of adding the average turnaround time to the provisional time is earlier than the time of subtracting the earlier arrival allowed time from the schedule time.

7. The smart scheduler of claim 4, wherein the final alarm time output unit outputs the provisional alarm time as the final alarm time, in case the time of adding the average turnaround time to the provisional alarm time falls between the schedule time and the time of subtracting the earlier arrival allowed time from the schedule time.

8. The smart scheduler of claim 3, wherein the alarm time decision unit increases a update frequency of the contextual information, as time draws to the schedule time.

9. The smart scheduler of claim 1, wherein the external service—providing source includes WEB or user.
